(19) United States
(12) Patent Application Publication
(10) Pub. No.: US 2009/0150118 A1
(43) Pub. Date: Jun. 11, 2009

(54) METHOD AND APPARATUS FOR SECURE WIRELESS TRACKING AND CONTROL

(76) Inventor: Reza Naima, San Francisco, CA (US)

Correspondence Address: SNELL & WILMER L.L.P. (Grumman), 600 ANTON BOULEVARD, SUITE 1400, COSTA MESA, CA, 92626, US

(21) Appl. No.: 12/065,491

(22) PCT Filed: Aug. 31, 2006
(86) PCT No.: PCT/US06/34183

§ 371 Date: Nov. 19, 2008

Related U.S. Application Data
(60) Provisional application No. 60/712,446, filed on Aug. 31, 2005.

(51) Int. Cl. G01M 17/00

(52) U.S. Cl. 702/165

(57) ABSTRACT

A method and system for determining a secondary mileage estimate for a vehicle is disclosed. The method includes measuring a travel speed of the vehicle over a period of time; integrating the current speed over said period of time to generate a secondary mileage estimate; and at least one of storing said secondary mileage estimate or transmitting said secondary mileage estimate to a server.

The instant disclosure claims the filing date of U.S. Provisional Application No. 60/712,446 filed Aug. 31, 2005, the specification of which is incorporated herein in its entirety.

### BACKGROUND

The present disclosure generally relates to a method and apparatus for remote automotive vehicle diagnosis, theft detection, secure and reliable odometer monitoring, and vehicle control utilizing an interface to the vehicle computer system.

In 1988 the Society of Automotive Engineers (SAE) established a standard connector and data protocol for interfacing with an engine computer. The EPA then mandated the On-board vehicle computer system (OBD) as a standard interface adapted from SAE recommendations. OBD II is an updated standard developed by SAE and adopted by the EPA and California Air Resources Board (CARB) on Jan. 1, 1996. An OBD-II connector is typically placed under the dashboard on the drivers' side of the vehicle.

The United States requires that all cars and light trucks built or sold in the United States after Jan. 1, 1996 to have an OBD-II connector. As engine control and other vehicular function control became available in engine computers, OBD connectors provided an interface between the engine computer and optional diagnostic and wireless data systems. This stimulated various improvements in the use of vehicle data.

In typical applications, an OBD's onboard computer receives information from various sensors, such as engine speed sensors, manifold pressure sensors, etc., and processes the information according to pre-defined criteria and adjustments (e.g., air/fuel mixture, fluid flow). Vehicles may also employ several separate microprocessor-based computer systems cooperating with one another to regulate the vehicle's performance. On-board communications systems generally include data busses enabling data communication between such vehicle computer systems. In addition, the communication systems may employ multiplexing to allow data transmission by a simple wire harness. Many vehicles employ direct access to monitor data on a real time basis. Accordingly, display tools and engine analyzers may also be used to perform a more complete diagnosis of engine problems than may be performed by on-board computers. For example, a data terminal connected to an input/output port of the vehicle computer or to an electronic control module may be provided under a dashboard.

Vehicles presently sold in the United States utilize a standardized diagnostic interface according to an OBDII/CARB protocol. The OBDII/CARB protocol provides an option between J1850 and ISO9141 standards. Handheld display tools are generally utilized to display code values generated by vehicle computers.

Vehicle manufacturers may employ different data standards even though the physical plugs and sockets are similar. For example, Ford uses an SAE J1850 PWM (Pulse Width Modulation) data standard, General Motors use an SAE J1850 VPW (Variable Pulse Width Modulation) data standard, and Chrysler, European and most Asian imports utilize ISO 9141 standards. The J1850 VPW standard uses a connector employing pins 2, 4, 5 and 16, the ISO 9141 standard uses a connector employing pins 4, 5, 7, 15 and 16, and the J1850 PWM standard uses a connector employing pins 2, 4, 5, 10 and 16. OBD II employs a standard pin assignment. For example, Pin 2 is for the J1850 Bus, Pin 4 is Chassis Ground, Pin 5 is Signal Ground, Pin 6 is CAN High (J-2284), Pin 7 is ISO 9141-2 K Line, Pin 10 is J1850 Bus, Pin 14 is CAN Low (J-2284), Pin 15 is ISO 9141-2 L Line, and Pin 16 is Battery Power. Additional complications may also be encountered in pre-OBD II vehicles and pre-1996 vehicles that were not OBD-II compliant.

Thus, the current OBD devices have limited compatibility, and hard-wired devices possess a limited functionality. Transmissions between vehicle diagnostic, theft, and control interfaces, including OBD, may also be intercepted, copied and/or retransmitted, and independently generated for dishonest external control of vehicles, overriding of theft transmission signals and illicit generation of false or misleading diagnostic information. In conventional methods, accumulated and updated odometer reading data may be stored in nonvolatile memory. An essential feature of this method is optimized addressing for the storage of the accumulated odometer reading data in the nonvolatile memory in order to avoid unnecessary writing/deletion access operations to the nonvolatile memory.

### SUMMARY

In one embodiment, the disclosure relates to providing a system and method for verification of diagnostic and odometer data to detect and assess whether proper maintenance has been timely performed and for confirming the actual mileage values.

In another embodiment, the disclosure relates to a secure wireless transmission and receipt of vehicle diagnostic, control, theft reporting and tracking information through interfacing the OBD or OBD II connector or by using other interface such as radio frequency links within the vehicle, vehicle optical interfaces, magnetic coupling and the like. Provision can be made to interface with the various currently OBD pin configurations including ISO, variable pulse width (VPW), pulse width modulation (PWM), and computer area network (CAN). Diagnostic data and vehicle control and alarm signals may also be encrypted and decrypted and stored in flash memory to enable remote reprogramming through encrypted communication.

Embodiments of the disclosure may additionally provide a decoy OBD connector to confound thieves intending to disable alarm systems and to allow permanent installation of embodiments of the present subject matter. System components may be modular to provide flexibility and cost reduction and may include multiband and multimode transceiver technologies providing communication in locations having poor cell phone reception. This enables alternative modes of communication.

In one embodiment, the diagnostic polling time is as a function of vehicle's age or mileage, time elapsed following most recent alarm or alert, and/or time lapsed since the most recent service. Further embodiments may include reliable storage, internal and/or external to a vehicle, to assure proper vehicle diagnostic and mileage data are maintained. Exemplary embodiments according to one aspect of the disclosure can include a processor programmed to tests for improper or erroneous diagnostic and odometer data to modify the apparent usage of said vehicle, errors from component failure, and static electric and transient data corruption. Exemplary algorithms for the processor may require periodic sampling of diagnostic and odometer data, testing for unusual or improbable variations (e.g., lower mileage indication or changes in mileage indication beyond the maximum vehicle velocity capabilities.) Code words within the transmitted odometer data, and encryption capabilities may further be included.

In one embodiment the disclosure relates a method for determining a secondary mileage of the vehicle includes: providing an on board vehicle computer system in the vehicle adaptable to communicate via a transceiver, measuring current speed of the vehicle, and integrating the current speed over a predetermined time period to generate a secondary value, and determining the secondary mileage of the vehicle. The method may also comprise the step of periodically verifying error codes provided by the system. Alternative embodiments may comprise the steps of storing the secondary mileage of the vehicle in a storage means and transmitting the secondary mileage to an external device or comparing an actual mileage of the vehicle to the secondary mileage.

In another embodiment, monitoring diagnostic information resident in an on board vehicle computer system by an external network includes providing a transceiver connected to the on board diagnostic system, the transceiver adaptable to wirelessly transmit and receive data, periodically verifying engine codes provided by the system to determine the operability status of the vehicle, and measuring current speed of the vehicle. The method may further include integrating the current speed over a predetermined time period to determine a secondary mileage estimate, and transmitting actual diagnostic information to the external network in correlation with the secondary mileage estimate. The step of integrating speed may use an average speed during said time period or it may use the speed measured at shorter intervals. Alternative embodiments may comprise the step of storing the engine codes.

In yet another embodiment, the disclosure relates to a method of extending the life of an on board vehicle diagnostic system by periodically querying engine codes provided by the on board diagnostic system, determining actual diagnostic information for the vehicle, storing the diagnostic information in a memory means, and securing power to the memory means. These steps may be repeated during engine operation. Alternative embodiments may include measuring current speed of the vehicle, and integrating the current speed over a predetermined time period to thereby correlate the diagnostic information with the mileage of the vehicle.

In an embodiment of the present subject matter a method of verifying odometer readings in a vehicle is provided comprising the steps of providing an on board vehicle computer system in the vehicle adaptable to transmit data via a transceiver, measuring current speed of the vehicle, and integrating the current speed over a predetermined time period to generate a secondary value. The method further comprises the steps of storing the secondary value, and determining a secondary odometer reading defined by the integrated speed of the vehicle. Further embodiments may comprise the step of transmitting the actual odometer reading to an external network. Alternative embodiments may include periodically verifying error codes provided by the system and correlating the verified error codes with the mileage prior to storing or reporting the same.

### BRIEF DESCRIPTION OF THE DRAWINGS

FIG. 1 is a schematic representation of a wireless multiband transceiver according to an embodiment of the disclosure.

FIG. 2 is a schematic diagram of a digital Input/Output (I/O) module according to an embodiment of the disclosure.

FIGS. 3A-3D are schematic diagrams of a mobile computer electronics unit according to an embodiment of the disclosure.

FIG. 4 is a flow diagram of a status routine according to an embodiment of the disclosure.

FIG. 5 is a flow diagram of a send engine routine according to an embodiment of the disclosure.

FIG. 6 is a representation of an odometer routine according to an embodiment of the disclosure.

### DETAILED DESCRIPTION

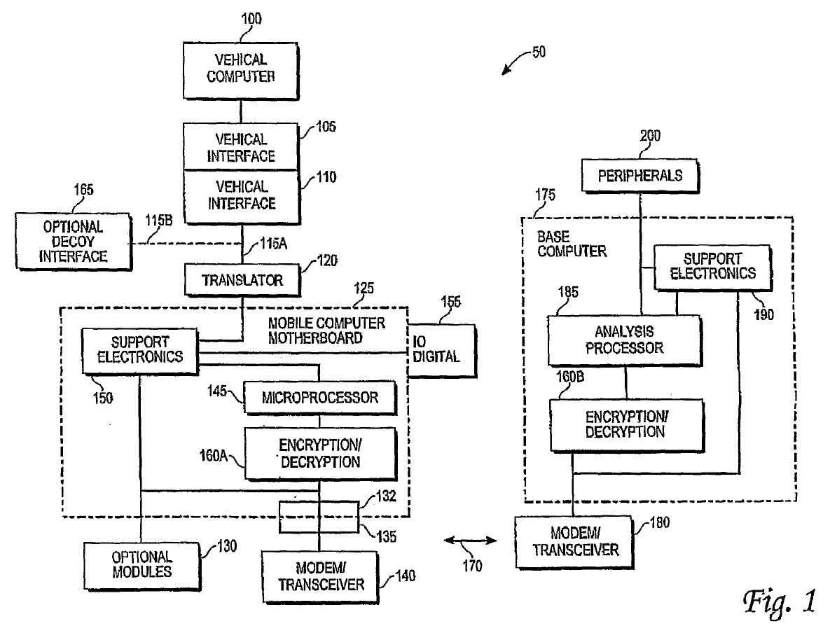

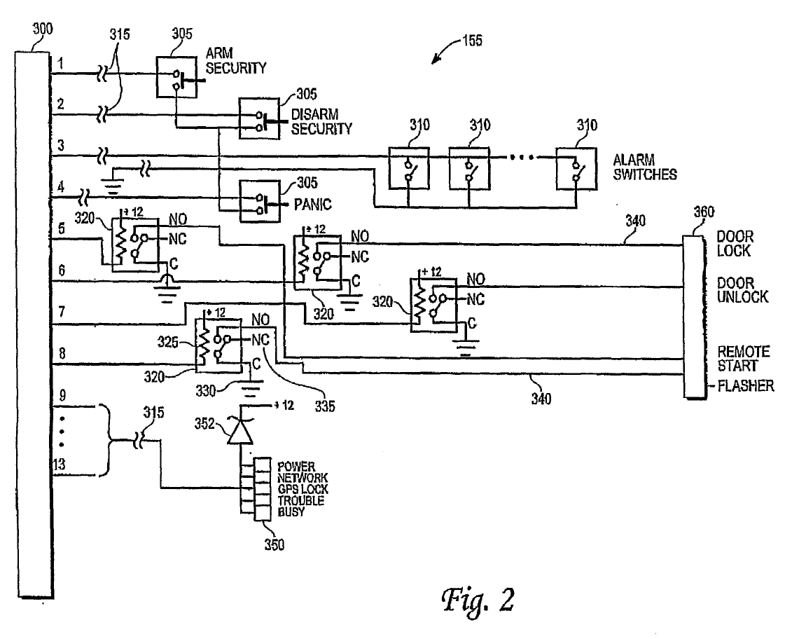

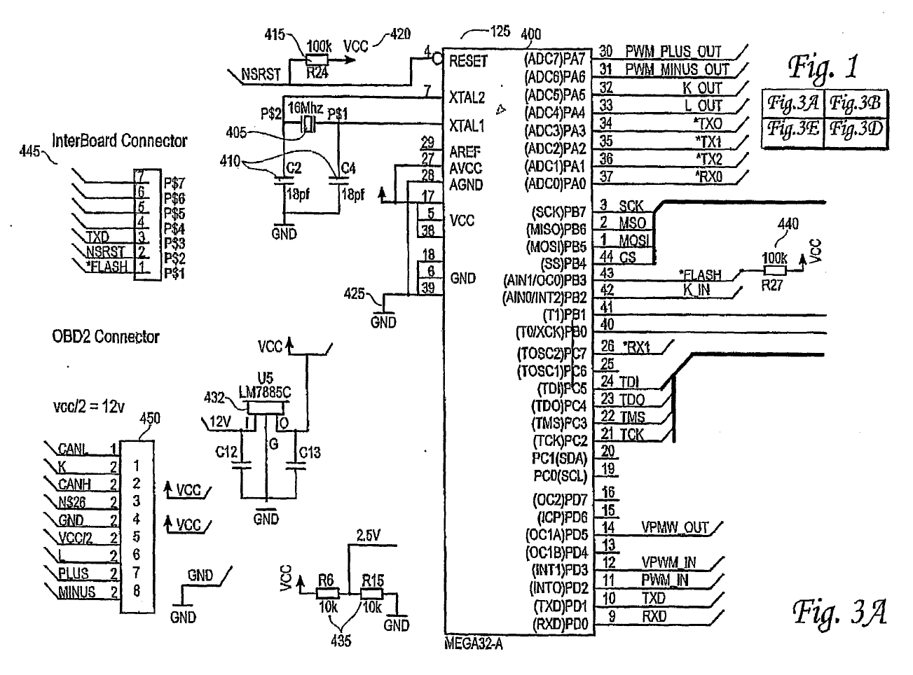

FIG. 1 is a schematic representation of a wireless multiband transceiver according to an embodiment of the present subject matter. With reference to FIG. 1, a tracking and control system 50 is illustrated including a vehicle's internal computer 100 and vehicle interface 105, such as OBD or OBD II connectors. The computer 100 may be a single microcomputer or microprocessor or multiple microcomputers or microprocessors that compose a vehicle's computer system. The vehicle interface connector 105 may also connect to a system interface connector 110 and to a translator 120 via an interface cable 115A. A mobile computer motherboard 125 supports the translator 120. Exemplary translators may be a daughter board or other printed circuit board or microprocessor that translates the pin connections for the various OBD interface pin configurations in use. Accordingly, several translators 120 may be provided in the control system 50 to accommodate pin allocations in various configurations of vehicle interface connectors. The aforementioned interconnections may translate power, ground, and transmit and receive various signals as will be described in further detail. For example, a translator 120 according to an embodiment of the present subject matter may be arranged to automatically detect a specific OBD pin configuration and interconnect the appropriate pins to the mobile computer motherboard 125. In a further embodiment, the translator 120 may be incorporated into the mobile computer motherboard 125 such that several versions of the motherboard may be provided in the control system. Interconnections may also be designed through the use of zero-ohm resistors as jumpers for low cost production and elimination of several parts to thereby provide the translator 120 as a connector or a flying lead from the motherboard 125.

The mobile computer motherboard 125 may be fabricated utilizing conventional printed circuit boards. The mobile computer motherboard 125 may further include connectors for a plurality of optional modules 130 such as, but not limited to, a modular, commercially available Global Positioning Satellite (GPS) receiver. Thus the GPS module may determine vehicle location and communicate data to a microprocessor 145 or another data receiver. Of course, the motherboard 125 may further include support electronics 150 such as, but not limited to, power conditioning, clock, logic, and line transceiver circuitry.

A digital input/output (I/O) 155 may be provided and interfaced with the motherboard 125. The digital I/O 155 may include relays, drivers, switches or other means for connection to solenoids, actuators, motors, sensor digital inputs and/or outputs for controlling and/or observing other onboard subsystems or mechanisms. In an embodiment of the present subject matter, a multiband transceiver may include a modular construction readily adaptable for expansion. Thus, the modular construction enables flexibility without fundamentally redesigning a system. Such flexible design provides various functional and modal capability including Diagnostic Only, Diagnostic & GPS, Diagnostic & GPS/Security, GPS Only, and GPS/Security configurations as well as vehicle control modes that may include security and/or GPS locating modules or modes. The modularity of the system reduces manufacturing costs while providing growth capability for users in the form of after-purchase accessory availability.

Microprocessor 145 may also include program memory, such as flash memory, EPROM, or EEPROM adaptable for internal reprogramming through command instructions. The microprocessor 145 may thus process data, format data and direct vehicle control components in real or near real time. The microprocessor 145 may also be programmed with appropriate software adaptable to reconfigure software portions stored in the flash memory, EPROM, or EEPROM.

An encryption/decryption module 160A may be provided as separate or integral hardware and/or software from the other modules of the motherboard 125. For example, the module 160A may include an algorithm as part of the program software and thus engage a range of complexities required by the use of the system or the security protocol. The encryption/decryption module 160A may also be programmed to implement different encryption techniques such as, but not limited to, asymmetrical encryption, classical byte addition encryption, character substitution encryption, or a binary Exclusive-OR scheme.

Motherboard 125 may also include transceiver connector 132 adaptable to mate with a modem/transceiver 140 via cable or data connector 135. Transceiver 140 enables wireless communication with base computer 175. In one embodiment, a connection to a base computer modem/transceiver 180 is provided via data connector 135 and mobile transceiver 140. Base computer transceiver 180 may utilize any number of available communication techniques such as cell phones, pager systems, satellite telephones, and multi-network systems adaptable to switch to satellite when normal cell phone coverage ceases. Embodiments of the disclosure may employ a FLEX+Satellite network protocol or other well known network protocols.

Computer modem/transceiver 180 may be similar to mobile modem/transceiver 140 and receive and process signals 170 with mobile computer motherboard 125 and provide data to base computer 175. Diagnostic, tracking and control data may be decrypted by encryption/decryption circuitry 160B which may comprise separate or integral hardware/software, or an algorithm as part of the program software or may engage a range of complexity as required by the use of the system and the security environment.

Decrypted data and messages are directed to analysis processor 185 for analyzing vehicle data and formatting requests and commands, identifying content and analyzing temporal variations in diagnostic parameters, engine status, location, speed and direction, alarm status, sensor data, and time. Support electronics 190 for the base computer 175 may comprise line drivers/receivers, power conditioning, clock and logic circuitry performing necessary functions common to computer systems. Base computer 175 may interface peripheral equipment 200 which may include printers, land-line modems, hard-drives, displays and information backup devices.

An optional decoy interface connector 165 can be included to interface with the vehicular system via an interface cable 11 SB or a standard vehicle interface connector 105 and inserted into a vehicle's under-dashboard mount. A thief might thereby be deceived into believing the vehicle is not alarmed, and proceed in his theft without the knowledge that the vehicle will be identified as stolen and subsequently tracked via a GPS system disclosed herein. The optional decoy interface connector 165 may also allow diagnostic scanners and the like for smog station monitoring and diagnostic equipment to be connected without requiring removal of the tracking and control system 50.

FIG. 2 is a schematic diagram of a digital I/O module according to an embodiment of the disclosure. In FIG. 2, a digital I/O connector 300 interfaces with the mobile computer motherboard 125 via pins 1 through 4 configured as digital inputs responsive to logical zero signals thereon, and pins 5 through 13 configured as digital outputs responsive commands provided from the microprocessor 145. Cables 315 allow locating push button switches 305 and alarm switches 310 at predetermined locations in a vehicle. Push button switches 305 may provide security ARM, DISARM, and PANIC inputs from an operator and alarm switches 310 may provide inputs from switches situated at vehicular access points (e.g., doors, windows, trunk and hood) to detect unauthorized entry into the vehicle. Relays 320 provide high current pathways to ground responsive to microprocessor commands for activating door lock circuitry, door unlock circuitry, remote start circuitry, and flasher circuitry, all associated with a hardwire connector 360. Relays 320 may further include activation coils 325, common terminals 330, normally closed terminals 335, and normally open terminals 340. Flasher circuitry connected to vehicle hardwire connectors 360 may be provided with periodic connections to ground for intermittently operating lights, horn and the like responsive to microprocessor commands resulting from intrusion detection via the alarm switches 310. Additional or alternative input switches and relay output connections such as proximity switches, vibration detection switches, automobile starter current disabling relays, start circuit actuators and others can also be included.

Digital I/O connector 300 may include an LED status array 350 powered through a 7.5-volt Zener diode 352 to indicate system status. If the vehicle is stolen, the I/O module 155 deactivates the engine once the thief turns off the engine. After the stolen vehicle is recovered, an owner may deactivate the engine-disabling code and operate the vehicle normally.

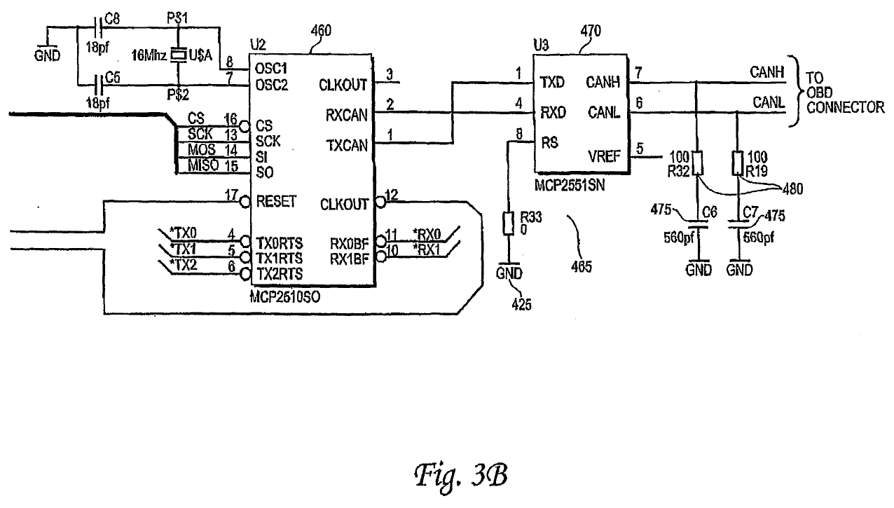

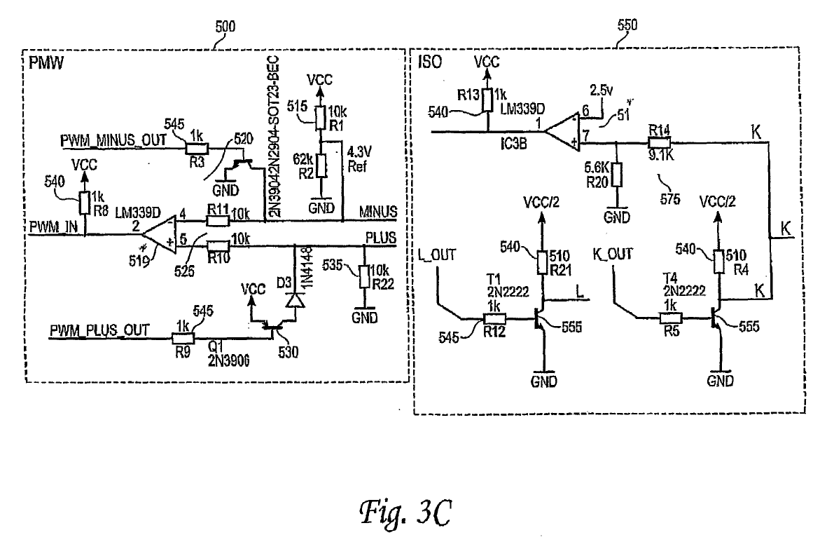

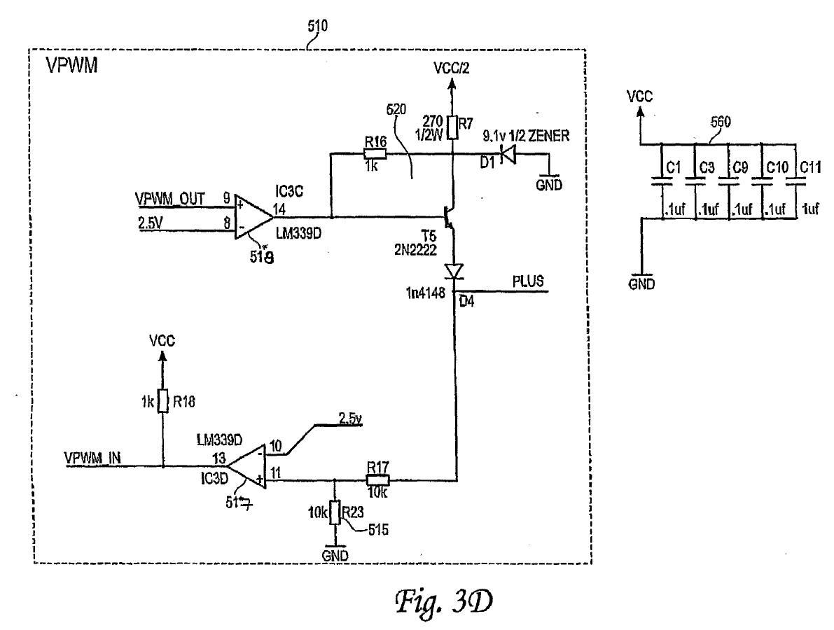

FIGS. 3A-3D provide an electrical schematic diagram of an embodiment of the mobile computer motherboard 125 illustrated in FIG. 1. With reference to FIG. 3A, a microprocessor 400 may be manufactured utilizing known CMOS technology. Connectors, resistors, capacitors, crystals, transistors, and diodes shown are commonly used in the electronics industry and are well known in the art. For example, a 16 MHz crystal 405 and 18 pF capacitors 410 may establish a clock reference for the microprocessor 400 and connect thereto via XTAL1 and XTAL2 ports.

A positive supply voltage VCC 420 and ground 425 may be provided by a vehicle battery and routed through to the microprocessor 400 via an OBD II connector 450. An U5 LM7805C 5-volt regulator circuit 432 or equivalent circuit may include filter capacitors C12 and C13 and is connected to the vehicle+12 volt supply through the OBD II connector 450. Pull-up resistors 415 and 440 may be utilized according to recommendations provided by a referenced data sheet, whereas most of the other inputs and outputs have optionally connected internal pull-up resistors actuated by software port commands. Transmit and receive signals along with clock, reset, and handshake signals of the microprocessor 400 are directed to a Controller Area Network (CAN) protocol controller 460 in FIG. 3B.

Output data receive and transmit signals are buffered in CAN transceiver 470 having differential outputs provided by pins 6 and 7 of the transceiver 470 and directed to the OBD II connector 450 shown in FIG. 3A. An R33 resistor 465 may be connected to thereby ground 435 to control and limit slew rate, and may be set for high-speed operation. R32 and R19 resistors 480 and C6 and C7 capacitors 475 may be utilized to match impedance of interconnecting cables to minimize electrical reflections.

FIG. 3C illustrates a quad comparator 519, which may be an LM339D or equivalent quad open-collector comparator device employed in a VPWM interface condition circuit 510. Additional embodiments of the present subject matter may employ the comparator 519 in a PMW 500 or ISO 550 interface conditioner circuit as illustrated in FIG. 3C. The comparator 519 may employ a 2.5-volt reference 430 to improve signal to noise in the interface conditioner circuits PMW 500, ISO 550, and VPWM 510 (FIG. 3D) to condition signals for supplying a vehicle with clean logic waveforms. Three resistor divider circuits 515 may be utilized to shift signal levels, and two discrete NPN transistor circuits 555 may be employed to invert signals L_OUT and K_OUT. A plurality of discrete pull-up resistors 540 may be provided included to define open collector circuit off states. Interface conditioner circuits 500, 510, 550 may utilize clamp circuits 520 and 530 to provide discrete logic. Isolation resistors 545 may be used to avoid loading of microprocessor outputs, and C1, C3, C9, C10, and C11 filter capacitors 560 distributed throughout the associated printed circuit board to decouple power supply noise.

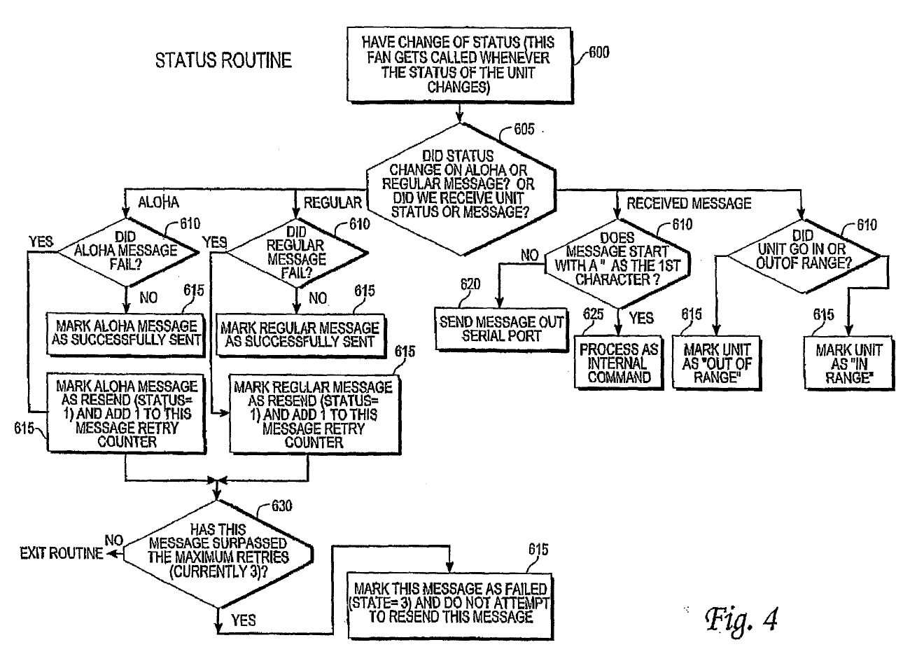

FIG. 4 is a flow diagram illustrating a status routine for handling status changes signaled by interrupts according to an embodiment of the disclosure. In FIG. 4, detection of a status change is represented by block 600 which is followed by decision logic relating to status change on an aloha or regular message and/or receipt of a unit status message as represented by block 605. Other protocols can be used without departing from the substance of the disclosure. Four outcomes of the decision block 605 are represented as decision blocks 610 having decision questions and logic to determine whether the aloha/regular message failed, whether the message start with a specific character, and whether the corresponding unit proceed in or out of range. Six outcomes of the decision blocks 610 represent mark instructions 615 that correlate to processes to set flags to a state of TRUE or FALSE for use in the status routine program or to include such flags in transmitted data. For example, if the status changed on an aloha or regular message, the routine will mark the associated status as resend and add “1” to a message retry counter. Conversely, if the status did not change, then the associated message will be marked as successfully sent. A limit decision logic represented by block 630 tests for allowable message repetitions tracked by the retry counter and either exits the routine or sets an appropriate flag.

By way of example, the routine may detect the content of the message by character identification and range analysis. If the unit status is in or out of range, the unit will be marked accordingly. Further, if the message is identified by its first character, then the routine may issue an internal software command as represented by block 625 or else issue a command to send data external to the processor as represented by block 620. The embodiment illustrated in FIG. 4 is exemplary in nature and non-limiting.

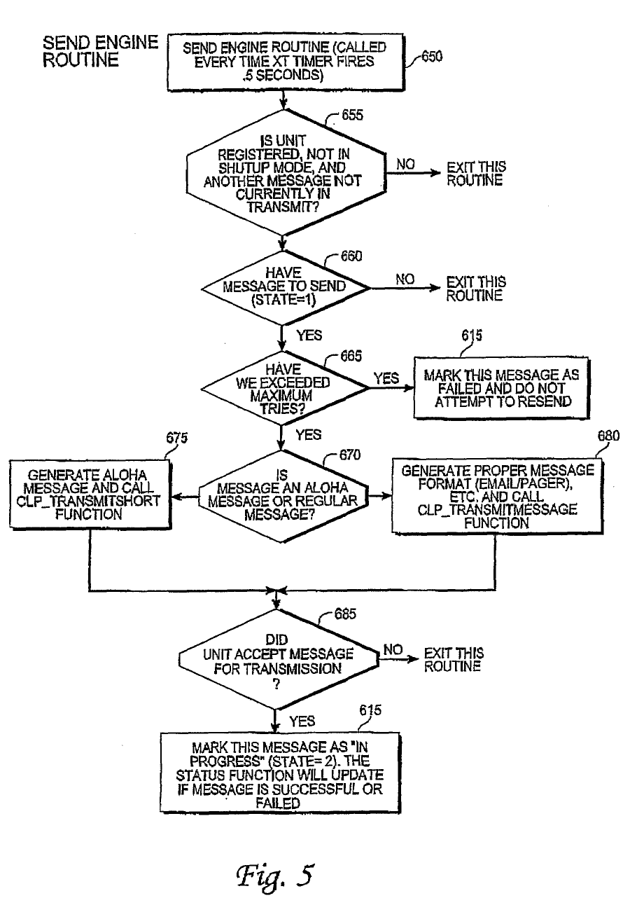

FIG. 5 is a flow diagram of a send engine routine for providing diagnostic status and sensor data of the vehicle internal computer. The same can be used to communicate mileage verification messages. In FIG. 5, a vehicle computer may be polled 650 to determine if a message is available (status change, sensor change, RPM change, error condition, check engine light, etc.). The polling period may be set to occurrences that meaningfully suggest a variation in polling period, such as vehicle age, time expired since the previous service, alert, alarm, speed, predetermined time periods, mileage, or the like. The polling period need not be constant and can be configured to increase or decrease according to defined milestones. Alternatively, the polling period may correspond to specific time intervals (5, 10, 15 seconds) and the resulting values may be integrated over time to produce additional data such as mileage. For mileage calculation the average speed over the period can be determined and the relationship between speed and time can be used to estimate a mileage value. This value can be used to verify the odometer reading or it can be used independent of the actual odometer reading to convey addition information. The mileage value can be wirelessly transmitted to a network and/or stored in a memory for future applications.

Decision blocks 655, 660, 665 and 685 represent a test of various flags and data against existing states to determine TRUE or FALSE state in each step and to direct the routine to either terminate the process or to set/reset a flag through mark instructions 615. The routine may be directed to format the message and data for transmission or issue a specified short transmission depending upon the type of message as represented by decision block 670. For example, the send engine routine may commence every time an XT timer fires 650. If the respective unit is registered, not in a shut-up mode and another message is not currently in transmit 655, then the routine verifies the message state 660, message type 670 and message counter 665. If the message state is any value other than “1” then the routine is terminated. Similarly, if the unit is not registered, is in a shut-up mode or another message is in transmit, then the routine is terminated. If the routine has exceeded the maximum number of retries, the message will be marked as failed and will not be resent 615. However, if the message is an aloha or regular message 670, the proper message will be formatted and prepared for transmission 675, 680. If the unit accepts the message for transmission 685, then the message will be marked as in progress and the status function will update if the message is successful or failed 615. Conversely, if the unit did not accept the message for transmission, then the routine is terminated.

An onboard computer or an ECU regularly receives diagnostic information (interchangeably, error codes) from various systems. To conserve memory space, original equipment manufacturers program the storage of the information at a frequency period of, for example, every 10 seconds. This frequency period cannot be changed. Thus, while the ECU may receive (“read”) error codes every second, the ECU stores (“writes”) the error codes once every ten seconds. Moreover, only the latest received error code is written into the memory. As a result, much of the received information is ignored.

An aspect of the present subject matter takes advantage of the available information by querying the ECU at shorter intervals (e.g., every second) and storing the information at an auxiliary memory module. That is, the ECU is tapped at shorter time intervals in order to capture (“read”) most, if not all, of the available information and error codes. Each read cycle may be followed by a write cycle whereby the error codes are stored at an auxiliary memory module. In addition, the read/write period may be changed as a function of the vehicle age, mileage or time elapsed since the preceding service.

The auxiliary memory module may comprise additional memory capacity for the vehicle. The auxiliary memory module may also be defined by a remote network that wirelessly receives the information and stores the same for future processing. In another embodiment, the information is collected continuously and stored in a local memory module. The stored information can be periodically transmitted to an auxiliary network for storage and further processing thereby enabling the auxiliary memory module to receive and store additional information.

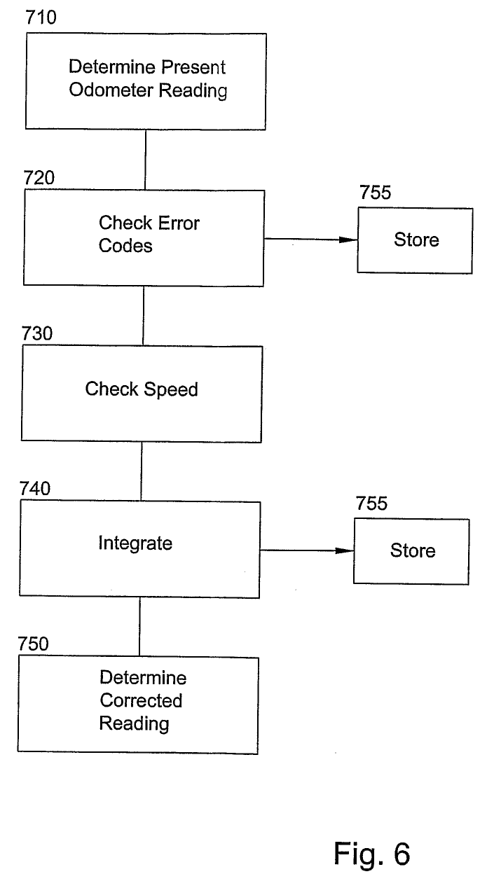

It may be necessary to convey error codes as a function of the vehicle's mileage. It may also be necessary to guard against mileage tampering. FIG. 6 is a schematic diagram of an odometer routine according to an exemplary embodiment. The odometer routine may include an algorithm that obtains and compares a secondary mileage estimate with the actual odometer reading. Alternatively, the algorithm may provide a secondary mileage estimate as a function of time, velocity and/or maximum possible vehicle speed. The routine can protect against software and hardware errors and ensure the integrity of odometer readings.

In step 710 the routine starts by checking a starting odometer value. This step can be done by using the actual odometer value or by retrieving a previously-stored secondary mileage estimate. In step 720 the algorithm checks the ECU for error codes. Step 720 may be optionally implemented and can serve several functions. First, by checking for error codes, the unit provides an auxiliary means for associating an operation failure with an actual mileage. Second, the error code can provide an indication of reliability of the odometer mileage value. The result can be stored in a memory (step 755) or wirelessly transmitted (not shown).

In step 730, the routine measures speed or receives an indication of speed from another source. In step 740, the routine integrates the speed over a period of time to determine the distance traveled during the time interval. The value of speed may be an average speed during the time interval. The time interval may be a predefined period. The result may be stored in a memory (step 755) or transmitted wirelessly to a remote processor (not shown). The results from step 740 may be added to the a previously-stored mileage estimates to obtain a cumulative or a secondary mileage estimate (step 750). If the secondary mileage estimate is inconsistent with the odometer reading, the calculation may be repeated for a subsequent interval. If the discrepancy is not resolved by the subsequent calculations, the discrepancy may be reported.

The exemplary steps shown in FIG. 6 may be programmed in an existing hardware or saved in an add-on module. The processor may possess remote programming and reporting capabilities. For example, a maintenance facility or a dealership may wirelessly contact the hardware to provide a code identifying an engine problem or communicate an upcoming service milestone.

Step 720 of FIG. 6 may be used independently or in conjunction with the secondary mileage estimation. As stated, conventional ECU systems detect and report error codes in regular time intervals. The time interval is predefined by the manufacturer and cannot be changed. Therefore, in one embodiment, the auxiliary system queries the ECU periodically in intervals shorter than that defined by the manufacturer. If any error codes are detected, the system reports the same to a repair facility as a function of the estimated or actual mileage. Thus, a repair facility or a dealer becomes aware of an upcoming problem and can advise the owner of an upcoming issue even before the check engine light indicates the problem.

In another embodiment, the disclosure relates to a method and system for remote tracking, monitoring and/or controlling a vehicle comprising an interface for connecting with the internal computer of the vehicle, a mobile computer for collecting vehicle data, processing the vehicle data, and controlling vehicle components, a transceiver for wirelessly and bi-directionally communicating with a base computer, and a processor in the base computer for analyzing the vehicle data and formatting requests and commands for the mobile computer. The interface may include a connector to connect to the vehicle interface connector (e.g., OBD port) and a translator for converting a plurality of vehicle interface connector configurations to said mobile computer. The mobile computer may include encryption/decryption circuitry to provide secure communications. The system may also include a digital I/O module for hardwired connections, sensing and control of vehicle components. The system may further include a GPS module for determining vehicle location and transmitting the vehicle location to the base computer. The transceiver may be a multimode transceiver to provide communication in alternative modes when a particular mode is compromised. The encryption/decryption circuitry may employ byte addition or character substitution algorithms and binary Exclusive-OR algorithms. The mobile computer may additionally include flash memory, EPROM or EEPROM to allow remote reprogramming of the software of the mobile computer.

The embodiments disclosed herein may be implemented as a board (a module, a microcomputer or a mobile computer) which interfaces or plugs into all motorized vehicles utilizing an OBD II port to poll the onboard computer or the ECU for diagnostic or status information as well as set various operating parameters. Information may further be transmitted wirelessly to an Internet website or offsite network or facility for further processing. The motherboard may be configured to communicate with various protocols (e.g., ISO, VPW, & PWM, CAN, KWP200) utilized for transmission of diagnostic information through OBD II ports on vehicles, equipment and machines. Some protocols may employ different hardware components for communication.

It is thus an aspect of the disclosure to enable accommodation of two or more types of OBD protocols. Once a device according to the present subject matter is attached to an OBD port, a motherboard senses which type of OBD protocol is present and selects the correct module on a Universal Scanner Board (USB) for information transfer. Two or more modules may be employed on a USB, with an option for additional modules for emerging protocols. Further, each module may be designed to accommodate one or more types of OBD protocols thus eliminating the requirement and expense of different board/scanner devices for different OBD protocols.

It is also an aspect of the disclosure to provide automatic generation of diagnostic information by an on-board vehicle computer (i.e., Freeze Frame) or poll the computer for any diagnostic, odometer, etc. information and faults. This information may then be wirelessly sent back to a server, network, or facility for processing. Embodiments of the present subject matter allow a user to set certain vehicle parameters such as maximum allowed speed or RPM. Such control may provide direct control of the vehicle either locally or from a remote site (e.g., a network, LAN, WAN or the Internet).

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A method of verifying odometer readings in a vehicle comprising:
(a) receiving a mileage indication from the vehicle's odometer readings;
(b) measuring speed of the vehicle during a first time interval and calculating a mileage estimate for said first time interval;
(c) obtaining a secondary mileage estimate by adding the mileage estimate for the first time interval to a cumulative mileage estimate for a time period prior to the first time interval; and
(d) comparing the secondary mileage estimate with the odometer mileage to verify the vehicle's odometer readings.

2. The method of claim 1, wherein step (d) further comprises reporting a discrepancy when the secondary mileage estimate fails to correspond to the odometer mileage.

3. The method of claim 1, further comprising storing the secondary mileage estimate as a cumulative mileage estimate at the end of the first period.

4. The method of claim 1, further comprising the step of:
(e) querying the vehicle's electronic system for an error code during the first time interval.

5. The method of claim 4, further comprising repeating steps (a)-(e) if an error code is detected.

6. The method of claim 4, wherein the error code is stored in relation to one of the odometer readings or the cumulative mileage estimate.

7. The method of claim 4, wherein the error code and a corresponding secondary mileage estimate are transmitted to a server.

8. The method of claim 4, wherein the step of querying for the error code further comprises querying the vehicle's electronic system more than once.

9. A system for providing a secondary mileage estimate for a vehicle comprising:
circuitry having at least one processor and a memory in communication with said processor;
wherein said at least one processor is programmed with instructions to:
(a) measure a travel speed of the vehicle over a first period of time,
(b) integrate the travel speed over said first period to generate a mileage estimate for said first period, and
(c) combine said mileage estimate for the first period with a cumulative mileage estimate for all times prior to the first period to obtain a secondary mileage estimate.

10. The system of claim 9, wherein said processor is further programmed with instructions to:
(d) compare the secondary mileage estimate with an actual odometer reading to detect an error.

11. The system of claim 9, further comprising a second processor programmed to query a vehicle's electronic system for error codes.

12. The system of claim 9, further comprising storing the secondary mileage estimate in the memory as the cumulative mileage estimate at the end of the first period.

13. The system of claim 11, further comprising a transmitter for communicating the detected error code and a corresponding secondary mileage estimate to a network.

14. A method for external monitoring of a vehicle's diagnostic information comprising:
(a) providing a transceiver connected to an electronic system of said vehicle, said transceiver configured for wireless communication;
(b) querying the electronic system during a first time interval to obtain diagnostic information;
(c) estimating the vehicle's mileage at the end of said first time interval as a function of the vehicle's speed during said first time interval; and
(e) communicating the diagnostic information as a function of the estimated vehicle mileage to an external network.

15. The method of claim 14, wherein estimating the vehicle's mileage further comprises integrating vehicle's speed over the first time interval.

16. The method of claim 14, wherein estimating the vehicle's mileage further comprises adding the mileage at the end of the first time interval to a cumulative mileage prior to the first time interval.

17. The method of claim 14, further comprising the step of:
(f) receiving an indication of the vehicle's actual odometer reading.

18. The method of claim 14, wherein the diagnostic information defines an error code.

19. The method of claim 14, wherein the diagnostic information defines a geographic position of the vehicle.

20. The method of claim 14, further comprising storing the queried diagnostic information as a function of the estimated vehicle mileage.

21. The method of claim 14, wherein the first time interval is shorter than a frequency period defined by the electronic system for storing the diagnostic information.

22. A system for monitoring a vehicle's diagnostic information comprising:
a circuitry in communication with the vehicle's electronic system;
a transmitter communicating with the circuitry and a remote network; and
a memory for storing diagnostic information;
wherein the circuitry is programmed with instructions to:
(a) query the onboard diagnostic system during a first interval to obtain diagnostic information,
(b) estimate the vehicle's mileage at the end of said first time interval as a function of the vehicle's speed during the first time interval and the vehicle's cumulative mileage, and
(c) store the queried diagnostic information as a function of the estimated vehicle mileage in the memory.

23. The system of claim 22, wherein the circuitry is further programmed with instructions to:
(d) transmit the stored diagnostic information to a network.

24. The system of claim 22, wherein the circuitry further comprises a first processor for communicating with the onboard diagnostic system and a second processor for estimating the vehicle's mileage.

25. The system of claim 22, wherein the circuitry is further programmed with instructions to
(d) obtain the vehicle's odometer mileage,
(e) compare the estimated vehicle mileage with the odometer mileage, and
(f) transmit the diagnostic information to a network as a function of one of the estimated vehicle mileage or the odometer mileage.

26. The system of claim 22, wherein the first time interval is shorter than a frequency period defined by the onboard diagnostic system for storing the diagnostic information.
